(19) United States
(12) Patent Application Publication
(10) Pub. No.: US 2013/0252483 A1
(43) Pub. Date: Sep. 26, 2013

(54) CONNECTING STRUCTURE FOR ELECTRONIC DEVICES

(71) Applicant: YAZAKI CORPORATION, Tokyo (JP)

(72) Inventor: Shinji MOCHIZUKI, Shizuoka (JP)

(73) Assignee: YAZAKI CORPORATION, Tokyo (JP)

(21) Appl. No.: 13/895,006

(22) Filed: May 15, 2013

Related U.S. Application Data
(63) Continuation of application No. PCT/JP2011/077278, filed on Nov. 18, 2011.

(30) Foreign Application Priority Data
Nov. 18, 2010 (JP) 2010-258229
Aug. 22, 2011 (JP) 2011-180846

(51) Int. Cl. H01R 13/17

(52) U.S. Cl. CPC H01R 13/17
USPC 439/786

(57) ABSTRACT

A connecting structure for electronic devices includes a plurality of busbars arranged parallel to each other with a space therebetween. Each of the busbars has a terminal part. The terminal part has at least two pairs of contact elastic pieces. Each of the pairs of the contact elastic pieces consists of two contact elastic pieces arranged laterally. The pairs of the contact elastic pieces are vertically arranged so as to form layers. Each of the contact elastic pieces of the busbars is configured to elastically come in contact with one of contact portions of at least one of electronic devices. At least two of the contact elastic pieces disposed in same one of the layers are elastically come in contact with the contact portions of the electronic device respectively, when the one of the electronic devices is attached to the connecting structure.

### BACKGROUND

The present invention is related to a connecting structure for electronic devices. The connecting structure can connect together electronic devices having different pitches in contact-to-contact.

Patent Document 1 discloses an electronic devices connecting structure which gains high reliability by ensuring the electric connection of electronic devices. As FIG. 20 shows, in this connecting structure, a pair of busbars 501, 503 and a semiconductor light emitting element (LED) 505, which is a light source, are assembled to a housing. The busbars 501, 503, which have a flat plate-like shape and which are the divided two busbars, have an electric wire connecting portion 507, a Zener diode connecting portion 509, a resistor connecting portion 511, and an LED connecting portion 513. The resistor connecting portion 511 includes press contact blades 515, 515 which are given individually to the busbars 501, 503 which are the divided two busbars. The Zener diode connecting portion 509 includes a single press contact blade 517 given to the busbar 501 and a single press contact blade 519 given to the busbar 503.

A Zener diode 521 is electrically connected to the busbar 501 at a lead portion 523 and to the busbar 503 at a lead portion 525 so that the Zener diode 521 is connected in parallel to the pair of busbars 501, 503 at a downstream side of a resistor 527. In this configuration, the Zener diode 521 protects the LED from a failure caused by an abrupt large voltage applied to the circuit by static electricity in a direction in which a forward electromotive force flows in the diode. The Zener diode 521 also disrupts the continuity in the circuit in a direction in which a backward electromotive force flows in the diode so as to protect the LED from a failure.

[Patent Document 1] JP-A-2007-149762

### SUMMARY

The conventional connecting structure for electronic devices needs the two types of busbars 501, 503 on which the connecting portions which are different in dimensions so as to match the shapes and sizes of the electronic devices. The connecting portions include the press contact blades 515, 515, the press contact blade 517, and the press contact blade 519. In addition, only the through-hole electronic devices having the lead portions can be mounted in the connecting structure, leading to a problem that surface mount electronic devices which have found many applications and hence have become inexpensive in recent years cannot be connected to the same construction. The electronic devices include the Zener diode 521 and the resistor 527.

It is therefore one advantageous aspect of the present invention to provide a connecting structure which enables the connection of a plurality of types of surface mount electronic devices having different contact-to-contact pitches, external shapes and sizes with busbars of one type.

According to one advantage of the invention, there is provided a connecting structure for electronic devices, the connecting structure comprising:
a plurality of busbars arranged parallel to each other with a space therebetween, wherein
each of the busbars has a terminal part,
the terminal part has at least two pairs of contact elastic pieces,
each of the pairs of the contact elastic pieces consists of two contact elastic pieces arranged laterally,
the pairs of the contact elastic pieces are vertically arranged so as to form layers,
each of the contact elastic pieces of the busbars is configured to elastically come in contact with one of contact portions of at least one of electronic devices, and
at least two of the contact elastic pieces disposed in same one of the layers are elastically come in contact with the contact portions of the electronic device respectively, when the one of the electronic devices is attached to the connecting structure.

The connecting structure may be configured such that: the electronic devices include a first electronic device and a second electronic device, two of the busbars are provided in the connecting structure, each of the busbars includes a pair of contact members arranged laterally, an end part of each of the contact members is branched to form two of the contact elastic pieces, four of the contact elastic pieces are arranged in each of two layers, two of the contact elastic pieces which are adjacent with each other are configured to be come in contact with a pair of the contact portions of the first electronic device respectively in one of the two layers, and two of the contact elastic pieces between which at least one of the contact elastic pieces is arranged are configured to be come in contact with a pair of the contact portions of the second electronic device respectively in the other of the two layers.

The connecting structure may be configured such that: each of the busbars is formed by being bent a plate into a U-shape so that each of the busbars includes a pair of side walls disposed in parallel to each other, and the contact elastic pieces are formed by punching the side walls.

The connecting structure may be configured such that: the one of the electronic devices is a semiconductor light emitting element, a light emitting portion of the semiconductor light emitting element is disposed between two of the busbars, and reflecting surface are formed on each of side surfaces of the busbars between which the light emitting portion is disposed.

### BRIEF DESCRIPTION OF DRAWINGS

FIG. 1 is a perspective view of two busbars which are used in a connecting structure for electronic devices according to a first embodiment of the invention.

FIG. 2 is a perspective view of a housing which accommodates the busbars shown in FIG. 1.

FIG. 3 is a perspective view of one of the busbars shown in FIG. 1.

FIG. 4A is a plan view of the busbars shown in FIG. 1.

FIG. 4B is a sectional view of the busbars taken along the line indicated by arrows A, A in FIG. 4A.

FIG. 4C is a sectional view of the busbars taken along the line indicated by arrows B, B in FIG. 4A.

FIG. 5A is a perspective view of a semiconductor light emitting element.

FIG. 5B is a perspective view of a Zener diode.

FIG. 6 is a drawing which depicts a busbars assembling step in the connecting structure according to the first embodiment of the invention.

FIG. 7 is a drawing which depicts similarly an electronic devices assembling step.

FIG. 8 is a drawing which depicts similarly a housing assembling step.

FIG. 9 is a drawing which depicts similarly an electric wire holder assembling step.

FIG. 10 is a perspective view of an LED unit which uses the connecting structure according to the first embodiment of the invention.

FIG. 11A is a plan view of an LED unit according to a modified example.

FIG. 11B is a sectional view of the LED unit taken along the line indicated by arrows C, C in FIG. 11A.

FIG. 11C is a sectional view of the LED unit taken along the line indicated by arrows D, D in FIG. 11A.

FIG. 12 is an enlarged view of a main part of the LED unit shown in FIG. 11C.

FIG. 13 is a perspective view of a busbar according to a modified example in which lateral side walls are partially cut to be erected.

FIG. 14A is a perspective view showing two busbars like the busbar shown in FIG. 13 as being aligned side by side.

FIG. 14B is a plan view of the busbars like the busbar shown in FIG. 13 as being aligned side by side.

FIG. 15 is a drawing which depicts a busbars assembling step in a connecting structure for electronic devices according to a second embodiment of the invention.

FIG. 16 is a drawing which depicts similarly an electronic devices assembling step.

FIG. 17 is a drawing which depicts similarly a housing assembling step.

FIG. 18 is a drawing which depicts similarly an electric wire holder assembling step.

FIG. 19 is a perspective view of an LED unit which uses the connecting structure according to the second embodiment of the invention.

FIG. 20 is a perspective view of a conventional connecting structure for electronic devices.

### DETAILED DESCRIPTION OF EXEMPLIFIED EMBODIMENTS

Hereinafter, an embodiment of the invention will be described by reference to the drawings.

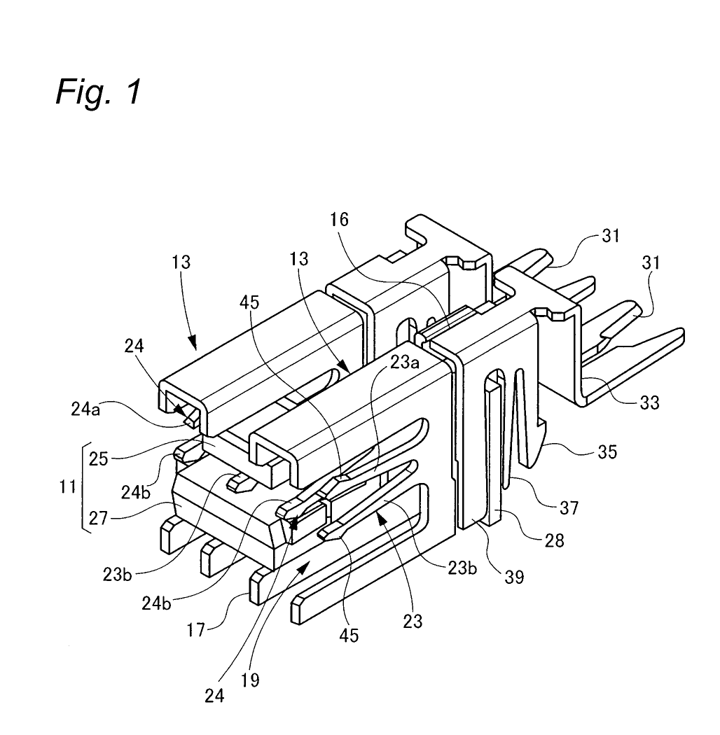

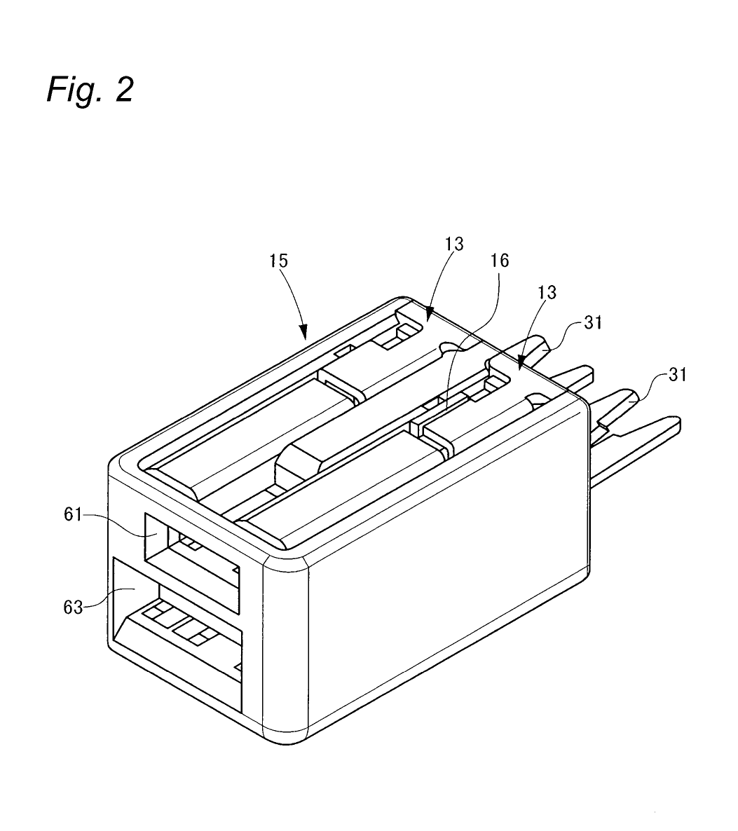

FIG. 1 is a perspective view of two busbars which are used in a connecting structure for electronic devices according to a first embodiment of the invention, and FIG. 2 is a perspective view of a housing which accommodates the busbars shown in FIG. 1.

A connecting structure for electronic devices 11 according to the first embodiment of the invention has two busbars 13 having the same shape shown in FIG. 1 as a main part of the configuration thereof. These two busbars 13 are accommodated in a housing 15 shown in FIG. 2 for use.

The two busbars 13 each have a terminal portion 19 which is formed at one end 17 thereof and are disposed parallel to each other with a space defined therebetween. The terminal portion 19 has at least a pair of contact elastic pieces 23, 24 which are disposed parallel to each other horizontally. The contact elastic pieces 23, 24 each include several vertically arranged contact elastic elements. The contact elastic elements include a pair of upper and lower contact elastic elements 23a, 23b/24a, 24b in this embodiment. In a sense, the upper contact elastic elements 23a, 24a of the contact elastic pieces 23, 24 form an upper pair of contact elastic elements which are disposed parallel to each other horizontally, and the lower contact elastic elements 23b, 24b thereof form a lower pair of contact elastic elements which are disposed parallel to each other horizontally. These contact elastic elements 23a, 24a, 23b, 24b can be brought into elastic contact with pairs of contact portions 21 of a plurality of types of electronic devices 11. The number of the types of electronic devices 11 is two in this embodiment.

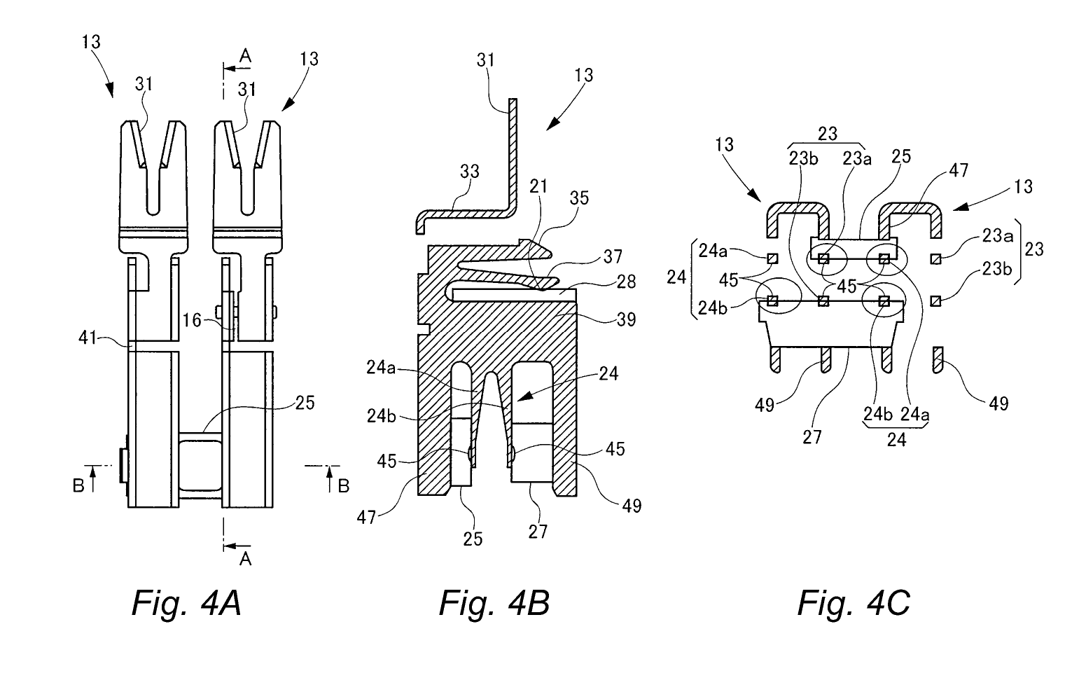

In this embodiment, as described above, one busbar 13 has the pair of contact elastic pieces 23, 24 which are each caused to branch into a substantially Y-shape so that the one busbar 13 has the two pairs of contact elastic elements 23a, 24a, 23b, 24b in total towards distal ends of the contact elastic pieces 23, 24. In the four upper contact elastic elements 23a, 24a, 23a, 24a of the busbars 13 which are disposed parallel to each other, electric contact portions 45 of the two adjacent contact elastic elements 24a, 23a of the busbars 13 are connected to a pair of contact portions 21 of a semiconductor light emitting element 25, which is a first electronic device 11 disposed between the two busbars 13 (refer to FIG. 4). In the four lower contact elastic elements 23b, 24b, 23b, 24b of the busbars 13 which are disposed parallel to each other, electric contact portions 45 of the two contact elastic elements 24b, 24b of the busbars 13, which are disposed spaced apart from each other so as to hold the contact elastic element 23b of the busbar 13 therebetween, are connected to a pair of contact portions 21 of a Zener diode 27, which is a second electronic device 11 which is disposed below the semiconductor light emitting element 25 between the two busbars 13 (refer to FIG. 4).

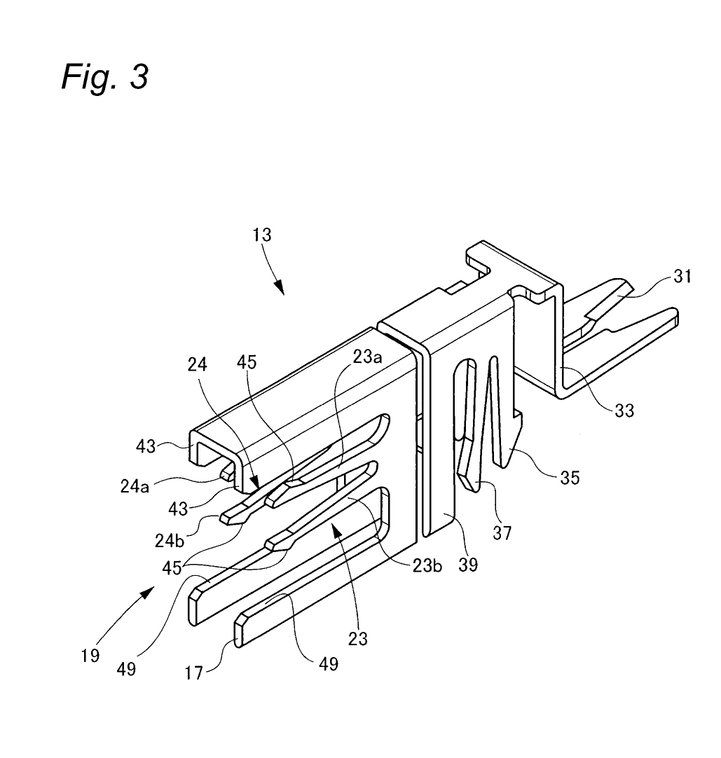

FIG. 3 is a perspective view of one of the busbars 13 shown in FIG. 1.

Part of the busbar 13 projects out of a housing 15 in such a state that the busbar 13 is mounted in the housing 15. In this embodiment, a side of the housing 15 from which part of the busbar 13 projects is referred to as a “rear” and an opposite side thereto is referred to as a “front.” A press contact blade 31 is provided at a rear end of the busbar 13 for establishing an electric contact between the busbar 13 and a conductor of a covered electric wire by cutting a covering thereof. Continuously formed forwards of the press contact blade 31 are a rear abutment piece 33, rear elastic legs 35, front elastic legs 37 and front abutment pieces 39.

The terminal portion 19, which is disposed at the one end 17 (the front end) of the busbar 13, is continuously provided with the front abutment piece 39 which lies on a back side of FIG. 3 via a connecting portion 41 (refer to FIG. 4A). The press contact blade 31, the rear abutment piece 33, the rear elastic legs 35, the front elastic legs 37, the front abutment pieces 39 and the terminal portion 19 are punched altogether out of a sheet of metal through sheet metal working and are then bent into a shape shown in FIG. 3. The terminal portion 19 of the busbar 13 is bent into a U-shape so that a pair of lateral side walls 43 become parallel to each other, and the contact elastic pieces 23, 24 are formed in the corresponding lateral side walls 43 through punching. A main body of the busbar 13 is bent into the U-shape, and the two pairs of contact elastic elements 23a, 24a, 23b, 24b are formed at the distal ends of the contact elastic pieces 23, 24 which are formed so as to branch into the substantially Y-shape through punching in the pair of lateral side walls 43 of the busbar 13 which face each other, whereby the elastic contact construction having a number of electric contact portions 45 can be fabricated compact with ease.

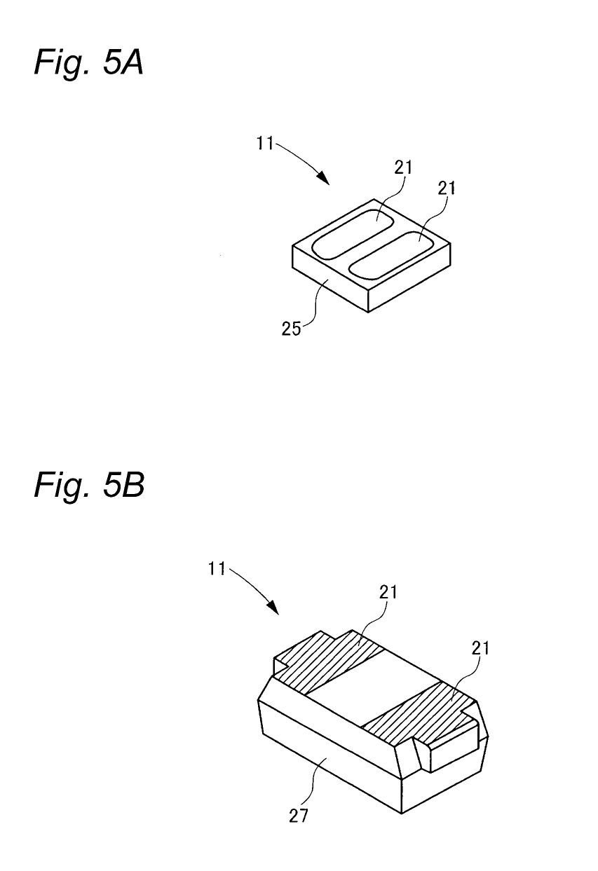

FIG. 4A is a plan view of the busbars 13 shown in FIG. 1, FIG. 4B is a sectional view of the busbar 13 taken along the line indicated by arrows A, A in FIG. 4A, FIG. 4C is a sectional view of the busbar 13 taken along the line indicated by arrows B, B in FIG. 4A, FIG. 5A is a perspective view of the semiconductor light emitting element 25, and FIG. 5B is a perspective view of the Zener diode 27.

In one busbar 13, the pair of contact elastic pieces 23, 24 are formed so as to be parallel to each other. The contact elastic pieces 23, 24 are each caused to branch into the substantially Y-shape so as to have the pair of contact elastic elements 23a, 23b/24a, 24b which are formed towards the distal end thereof. In other words, the contact elastic elements 23a, 24a form the upper pair of contact elastic elements and the contact elastic elements 23b, 24b form the lower pair of contact elastic elements. The electric contact portions 45 formed at respective distal ends of the contact elastic elements 23a, 24a, 23b, 24b so as to project therefrom are each formed into a triangular shape whose apex is configured as a contact point. As is shown in FIG. 4A, the two busbars 13 are disposed parallel to each other with a space defined therebetween. According to this configuration, in each of the busbars 13 which are disposed parallel to each other, four electric contact portions 45 are provided to be disposed at the distal ends of the contact elastic elements 23a, 24a, 23b, 24b. Thus, in the two busbars 13, eight electric contact portions 45 in total are provided to be disposed at the distal ends of the two pairs of contact elastic elements 23a, 24a, 23b, 24b, as is shown in FIG. 4C. Upper part seating portions 47 are formed on the busbars 13 so as to face the four upper electric contact portions 45 of the four upper contact elastic elements 23a, 24a, 23a, 24a of the busbars 13 which are disposed parallel to each other. In addition, lower part seating portions 49 are formed on the busbars 13 so as to face the four lower electric contact portions 45 of the four lower contact elastic elements 23b, 24b, 23b, 24b of the busbars 13 which are disposed parallel to each other.

The semiconductor light emitting element 25 is mounted between the upper part seating portions 47 and the corresponding four upper electric contact portions 45 of the four upper contact elastic elements 23a, 24a, 23a, 24a. The Zener diode 27 is mounted between the four lower electric contact portions 45 of the four lower contact elastic elements 23b, 24b, 23b, 24b and the corresponding lower part seating portions 49. As is shown in FIG. 5A, the semiconductor light emitting element 25 is a surface mount electronic device 11 on one surface of which a pair of contact portions 21 are provided. In addition, as is shown in FIG. 5B, the Zener diode 27 is also a surface mount electronic device 11 on one surface of which a pair of contact portions 21 are provided.

As is shown in FIG. 4C, the semiconductor light emitting element 25 is brought into abutment with the upper part seating portions 47 on a back side thereof with the side where the contact portions 21 are provided oriented towards the electric contact portions 45 of the upper adjacent contact elastic elements 23a, 24a. The Zener diode 27 is brought into abutment with the lower part seating portions 49 on a back side thereof with the side where the contact portions 21 are provided oriented towards the electric contact portions 45 of the lower adjacent contact elastic elements 23b, 24b.

In this embodiment, a contact-to-contact pitch of the semiconductor light emitting element 25 is smaller than a contact-to-contact pitch of the Zener diode 27. Namely, the two electronic devices 11 have different contact-to-contact pitches. In this embodiment, the two types of electronic devices 11 having the different contact-to-contact pitches are allowed to be mounted in the electronic devices connecting construction for electronic devices 11 at the same time. Namely, as is shown in FIG. 4C, in the four upper contact elastic elements 23a, 24a, 23a, 24a of the busbars 13 which are disposed parallel to each other, the electric contact portions 45 of the adjacent contact elastic elements 24a, 23a are in contact with the pair of contact portions 21 of the semiconductor light emitting element 25. In the four lower contact elastic elements 23b, 24b, 23b, 24b of the busbars 13 which are disposed parallel to each other, the electric contact portions 45 of the two adjacent contact elastic elements 24b, 24b of the busbars 13, which are disposed spaced apart from each other so as to hold the contact elastic element 23b of the busbar 13 therebetween, are in contact with the pair of contact portions 21 of the Zener diode 27.

Namely, in FIG. 4C, the semiconductor light emitting element 25 is connected to the second leftmost electric contact portion 45 and the third leftmost electric contact portion 45 in the upper electric contact portions 45 of the busbars 13 which are disposed parallel to each other. In addition, the Zener diode 27 is connected to the first leftmost electric portion 45 and the third leftmost electric portion in the lower electric contact portions 45 of the busbars 13 which are disposed parallel to each other. However, the Zener diode 27 can also be connected to the second leftmost electric contact portion 45 and the fourth leftmost electric contact portion 45. In this embodiment, the contact-to-contact pitch of the Zener diode 27 used is double the contact-to-contact pitch of the adjacent electric contact portions 45. However, a Zener diode 27 can also be used which has a contact-to-contact pitch which is three times the contact-to-contact pitch of the adjacent electric contact portions 45. As this occurs, a pair of contact portions 21 of the Zener diode 27 are connected to the first leftmost electric contact portion 45 and the fourth leftmost electric contact portion 45.

Next, assembling steps of the connecting structure for electronic devices 11 will be described.

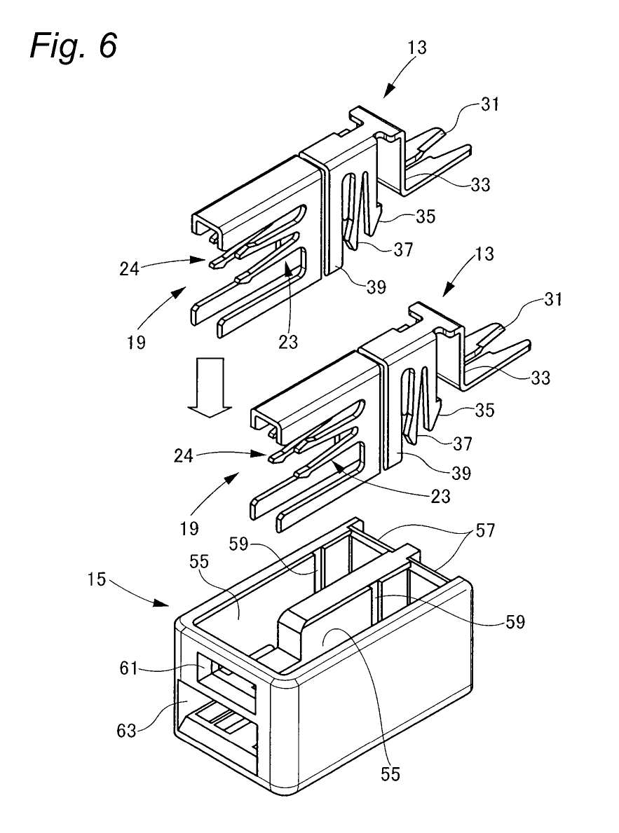

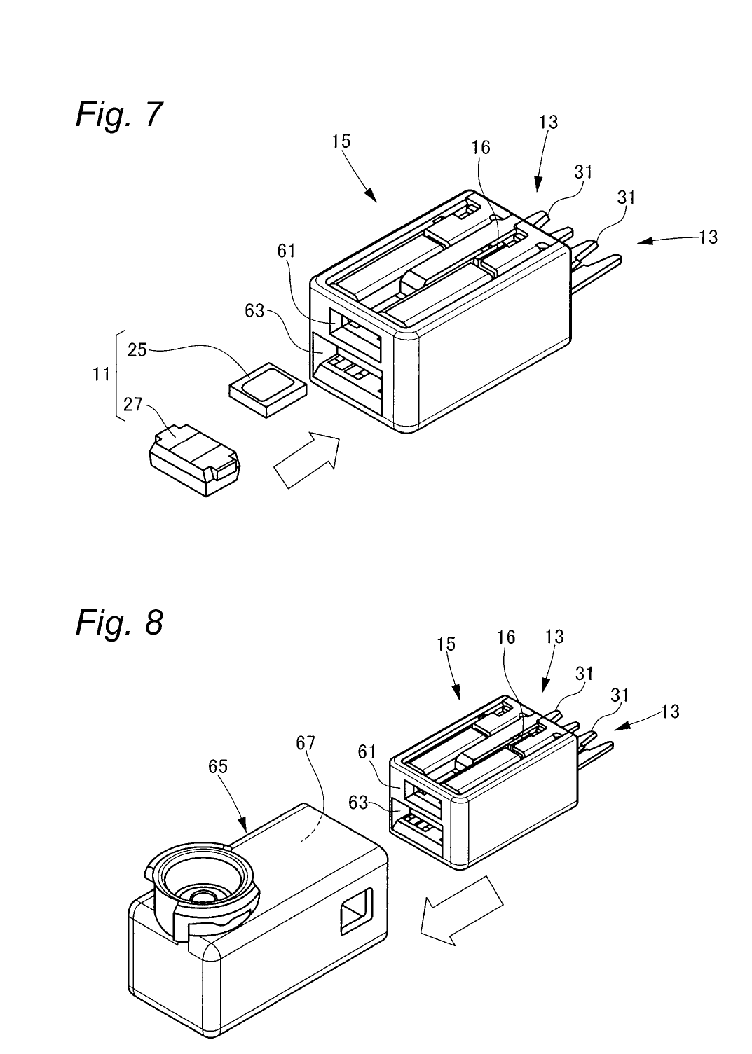

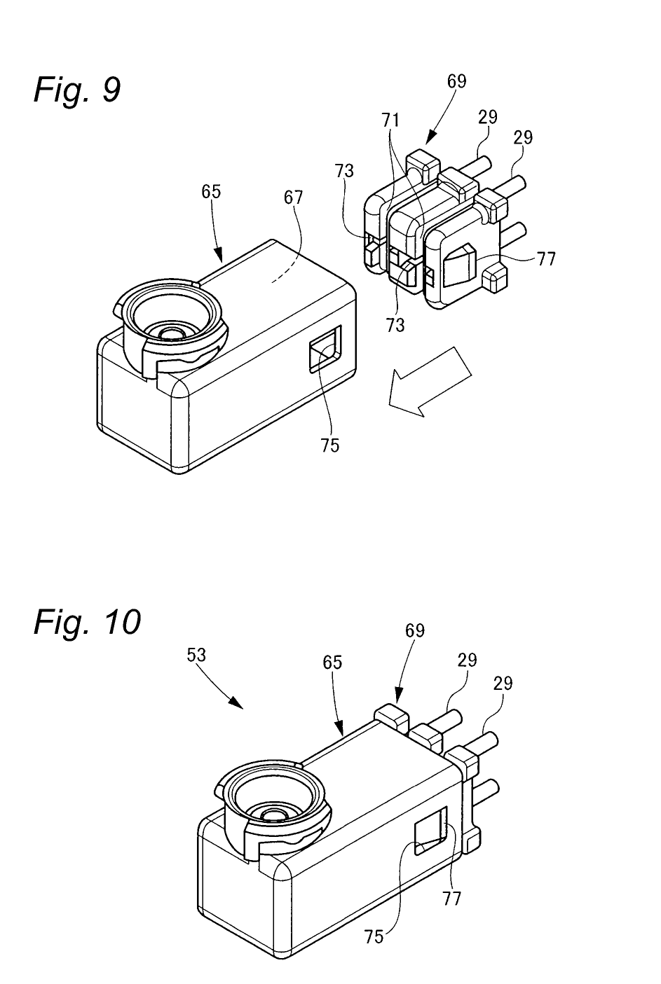

FIG. 6 is a drawing which depicts a busbars assembling step in the connecting structure for electronic devices 11 according to the first embodiment of the invention, FIG. 7 is a drawing which depicts similarly an electronic devices assembling step, FIG. 8 is a drawing which depicts similarly a housing assembling step, FIG. 9 is a drawing which depicts similarly an electric wire holder assembling step, and FIG. 10 is a perspective view of an LED unit 53 which uses the connecting structure for electronic devices 11 according to the first embodiment of the invention.

The connecting structure for electronic devices 11 can preferably be adopted for an LED unit 53, for example. In application of the connecting structure for electronic devices 11 to the LED unit 53, as is shown in FIG. 6, the two busbars 13 are mounted in the housing 15.

Two busbar accommodation compartments 55 are formed in the housing 15. In each of the busbar accommodation compartments 55, a rear wall 57 is formed at a rear thereof, and a pair of holding grooves 59 are formed on inner wall surfaces which lie forwards of the rear wall 57. In the busbar 13 inserted into the busbar accommodation compartment 55, the rear wall 57 is held by the rear abutment piece 33 and the rear elastic legs 35, so that the busbar 13 is mounted in the housing 15 while being restricted from being dislodged therefrom.

As is shown in FIG. 7, an LED mounting opening portion 61 and a diode mounting opening portion 63 are formed in a front side of the housing 15 so as to be disposed vertically. The semiconductor light emitting element 25 is inserted into the LED mounting opening portion 61 with the contact portions 21 oriented downwards. The Zener diode 27 is inserted into the diode mounting opening portion 63 with the contact portions 21 oriented upwards. By the electronic components being inserted into the housing 15 in the ways described above, as is shown in FIG. 4C, the contact portions 21 thereof are connected to the corresponding electric contact portions 45. In addition, a resistor mounting opening portion (not shown) is formed in a bottom side of the housing, and the resistor 28 is inserted thereinto. By this configuration, the resistor 28 is held by the front abutment pieces 39 and the front elastic legs 37 of the busbar 13 disposed on a near side, and electric contact portions of the front elastic legs 37 are connected a pair of contact portions of the resistor 28 (refer to FIG. 1).

Here, the LED unit 53 according to this embodiment needs a circuit in which resistors 28 are provided, respectively, between the semiconductor light emitting element 25 and the Zener diode 27 and between an anode terminal and a cathode terminal. Then, as FIG. 7 shows, a cutaway portion 16 is formed between the pair of front abutment pieces 39 and the pair of front elastic legs 37 of the near side busbar 13, whereby the resistor 28 mounted in the near side busbar 13 is connected with the semiconductor light emitting element 25 and the Zener diode 27 in series.

As FIG. 8 shows, the housing 15 in which the semiconductor light emitting element 25 and the Zener diode 27 are mounted is mounted, in turn, in a lens cover 65. A housing inserting opening portion 67 is formed in a rear end face of the lens cover 65. In the housing 15 inserted into the lens cover 65, the press contact blades 31 project rearwards in an interior of the lens cover 65.

As FIG. 9 shows, an electric wire holder 69 is inserted into the lens cover 65 in which the housing 15 is mounted from the housing inserting opening portion 67. U-shaped electric wire holding grooves 71 are formed at two locations over three external surfaces of the electric wire holder 69. A covered electric wire 29 is bent into a U-shape to be mounted in each of the electric wire holding grooves 71. Horizontal press contact blades entrance slits 73 are formed in a front side of the electric wire holder 69 so as to straddle the corresponding electric wire holding grooves 71. In this configuration, when the electric wire holder 69 is inserted into the lens cover 65, the press contact blades 31 of the busbars 13 which project rearwards in the interior of the lens cover 65 enter the corresponding press contact blade entrance slits 73, whereby the press contact blades 31 and conductors of the electric wires 29 are connected together.

When the electric wire holder 69 is inserted into the lens cover 65, locking claws 77 provided on lateral sides of the electric wire holder 69 so as to project therefrom are locked in corresponding locking holes 75 formed in lateral side portions of the lens cover 65, whereby the dislodgement of the housing 15 from the lens cover 65 and the electric wire holder 69 from the lens cover 65 is restricted. The LED unit 53 shown in FIG. 10 is completed by the housing 15 and the electric wire holder 69 being mounted in the lens cover 65.

In this way, in the connecting structure for electronic devices 11 of the first embodiment, the two busbars 13 having the terminal portions 19 are disposed parallel to each other with the space defined therebetween, and the terminal portion 19 includes the pair of contact elastic pieces 23, 24 each having the pair of contact elastic elements 23a, 23b/24a, 24b which face each other vertically. In other words, the contact elastic element 23a of the busbar 13 and the contact elastic element 24a of the other busbar 13 form the upper pair of contact elastic elements which face each other horizontally, and the contact elastic element 23b of the busbar 13 and the contact elastic element 24b of the other busbar 13 form the lower pair of contact elastic elements which face each other horizontally. Then, in the upper four contact elastic elements 23a, 24a, 23a, 24a of the busbars 13 which are disposed parallel to each other, the electric contact portions 45 of the two adjacent contact elastic elements 24a, 23a of the busbars 13 are connected to the pair of contact portions 21 of the semiconductor light emitting element 25 which is disposed between the two busbars 13. In addition, in the lower four contact elastic elements 23b, 24b, 23b, 24b of the busbars 13 which are disposed parallel to each other, the electric contact portions 45 of the contact elastic elements 24b, 24b of the busbars 13 which are disposed spaced apart from each other so as to hold the contact elastic element 23b of the busbar 13 therebetween are connected to the pair of contact portions 21 of the Zener diode 27 which is positioned below the semiconductor light emitting element 25 between the two busbars 13, whereby the electronic devices 11 having the different contact-to-contact pitches, external shapes and sizes can be connected together.

In addition, the two busbars 13 are disposed parallel to each other with the space defined therebetween, and each busbar 13 has the pair of contact elastic pieces 23, 24 which are each caused to branch into the substantially Y-shape so that each contact elastic piece 23/24 has the pair of contact elastic elements 23a, 23b/24a, 24b which are provided towards the distal end thereof while facing each other vertically. In other words, each busbar 13 has the two upper and lower pairs of contact elastic elements 23a, 24a, 23b, 24b which face each other horizontally. Thus, each busbar 13 has the four electric contact portions 45 and the two busbars 13 have the eight electric contact portions 45 in total. By adopting this configuration, in the four upper contact elastic elements 23a, 24a, 23a, 24a of the two busbars 13 which are disposed parallel to each other with the space defined therebetween, the electric contact portions 45 of the two adjacent contact elastic elements 24a, 23a of the busbars 13 can be connected to the semiconductor light emitting element 25 whose size and contact-to-contact pitch are small. In addition, in the four lower contact elastic elements 23b, 24b, 23b, 24b of the two busbars 13, the two contact elastic elements 24b, 24b of the busbars 13 which are disposed spaced apart from each other so as to hold the contact elastic element 23b of the busbar 13 therebetween can be connected to the Zener diode 27 whose size and contact-to-contact pitch are large.

Next, modified examples made to the connecting structure for electronic devices 11.

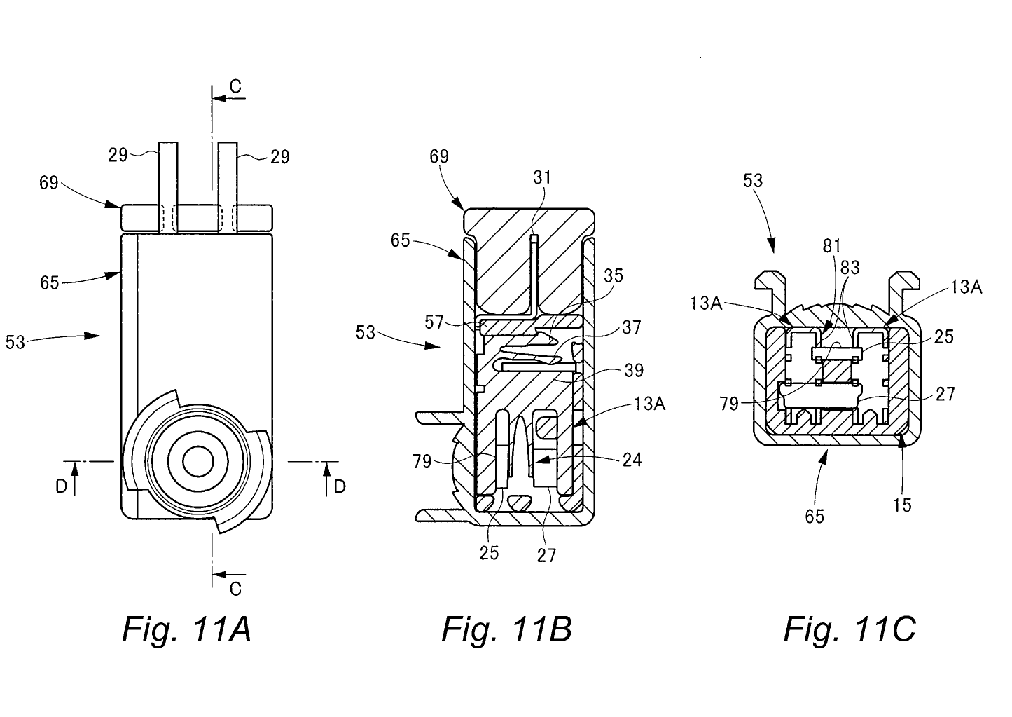

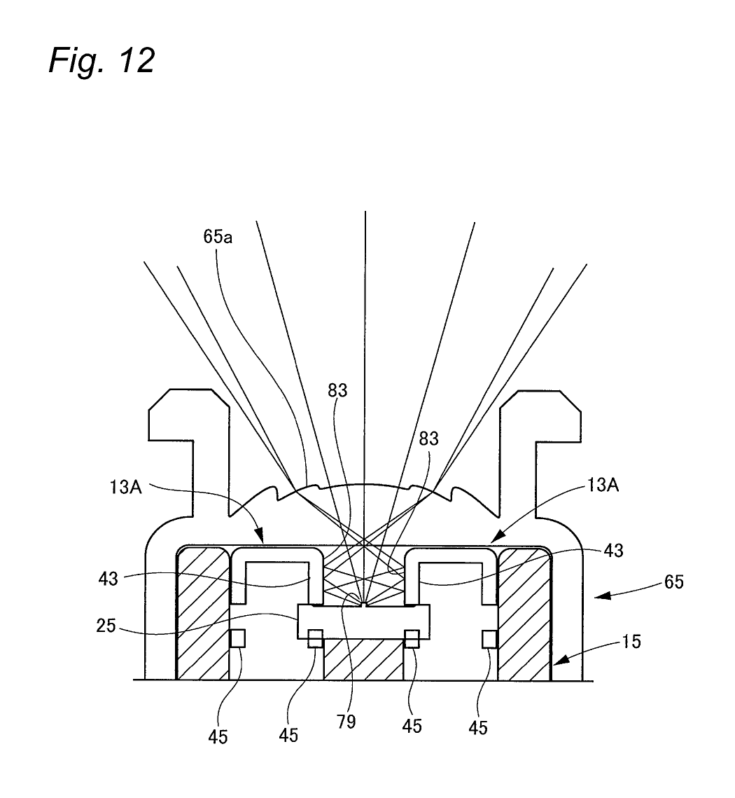

FIG. 11A is a plan view of an LED unit 53 according to a modified example, FIG. 11B is a sectional view of the LED unit 53 taken along the line indicated by arrows C, C in FIG. 11A, and FIG. 11C is a sectional view of the LED unit 53 taken along the line indicated by arrows D, D in FIG. 11A. FIG. 12 is an enlarged view of a main part of the LED unit 53 shown in FIG. 11C.

In a connecting structure for electronic devices 11 according to this modified example, one of electronic devices 11 is a semiconductor light emitting element 25, and a light emitting portion 79 thereof is disposed between two busbars 13A. On the other hand, in the two busbars 13A, a reflecting surface 83 is formed on each of lateral side wall surfaces 81 which face each other across the light emitting portion 79.

In this modified example, the light emitting portion 79 of the semiconductor light emitting element 25 is disposed so as to be held between the two busbars 13A which are disposed parallel to each other with a space defined therebetween. The reflecting surface 83 is formed on each of the lateral side wall surfaces 81 of lateral sides 43 of the two busbars 13A which hold the light emitting portion 79 therebetween, whereby as FIG. 12 shows, light emitted from the light emitting portion 79 is reflected by the reflecting surfaces 83 so as to be directed towards a lens 65a of a lens cover 65 which is disposed in the direction of emission of light, whereby the light emitted from the light emitting portion 79 can be used effectively.

Next, another modified example will be described.

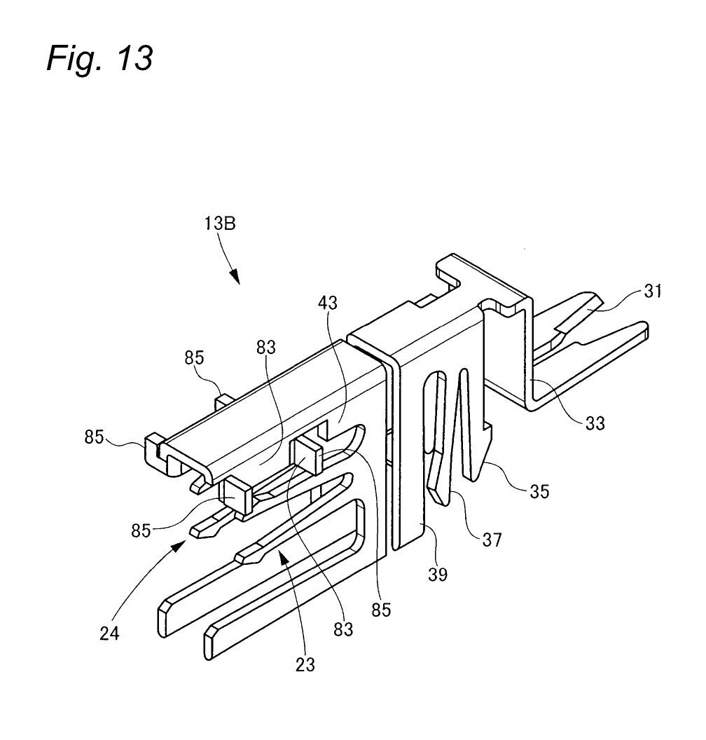

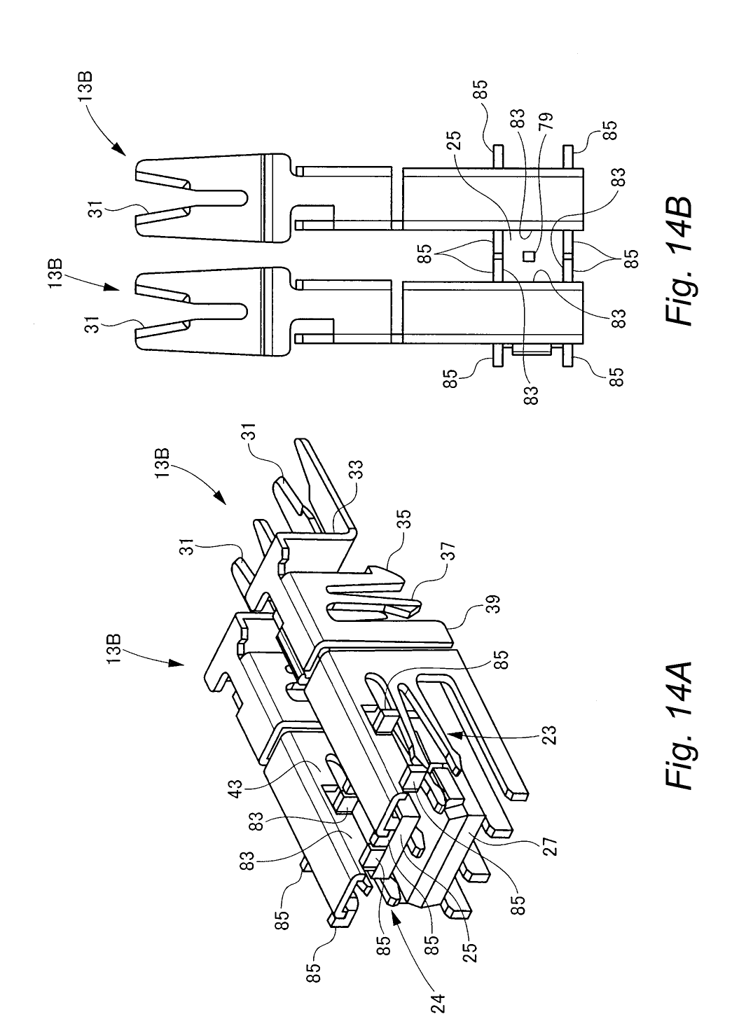

FIG. 13 is a perspective view of a busbar 13B according to a modified example in which lateral side walls 43 are partially cut to be erected, FIG. 14A is a perspective view showing two busbars like the busbar 13B shown in FIG. 13 as being aligned side by side, and FIG. 14B is a plan view of the busbars 13B so aligned.

In a connecting structure for electronic devices 11 according to this modified example, as FIG. 13 shows, distal end portions and portions lying further rearwards than the distal end portions of lateral side walls 43 of a busbar 13B are cut to be erected so that a pair of front and rear vertical pieces 85 project on each of the lateral side walls 43. As with the previous example, two busbars 13B like the busbar 13B just described are provided side by side a pair of contact elastic piece 23 of one busbar 13B and a pair of contact elastic pieces 24 of the other busbar 13B become parallel to each other, whereby the front vertical pieces 85 and the rear vertical pieces 85 on the lateral side walls 43 of the busbars 13B are butted up against each other. Facing surfaces of the vertical pieces 85 are configured as reflecting surfaces 83.

By adopting this configuration, as FIG. 14 shows, a light emitting portion 79 is surrounded around four sides thereof by reflecting surfaces 83 which are formed on a pair of parallel lateral side walls 43 and a pair of reflecting surfaces 83 formed on vertical pieces 85 which are perpendicular to the reflecting surfaces 83 on the lateral side walls 43 and in which a pair of vertical surfaces 85 which are butted up against each other face the other pair of vertical surfaces 85 which are also butted up against each other. According to this configuration, almost no light leakage occurs, thereby making it possible to make effective use of light emitted from the light emitting portion 79.

Consequently, according to the connecting structure for electronic devices 11 of this embodiment, with one type of busbars 13, two types of surface mount electronic devices 11 having different contact-to-contact pitches, external shapes and sizes can be connected together.

In the first embodiment, while the connecting structure for electronic devices 11 has been described which has the two busbars 13 having the same shape as the main part of the configuration thereof, the connecting structure according to the invention is not limited thereto. Therefore, there may be provided a connecting structure which has three or more busbars having the same shape as a main part of the configuration thereof.

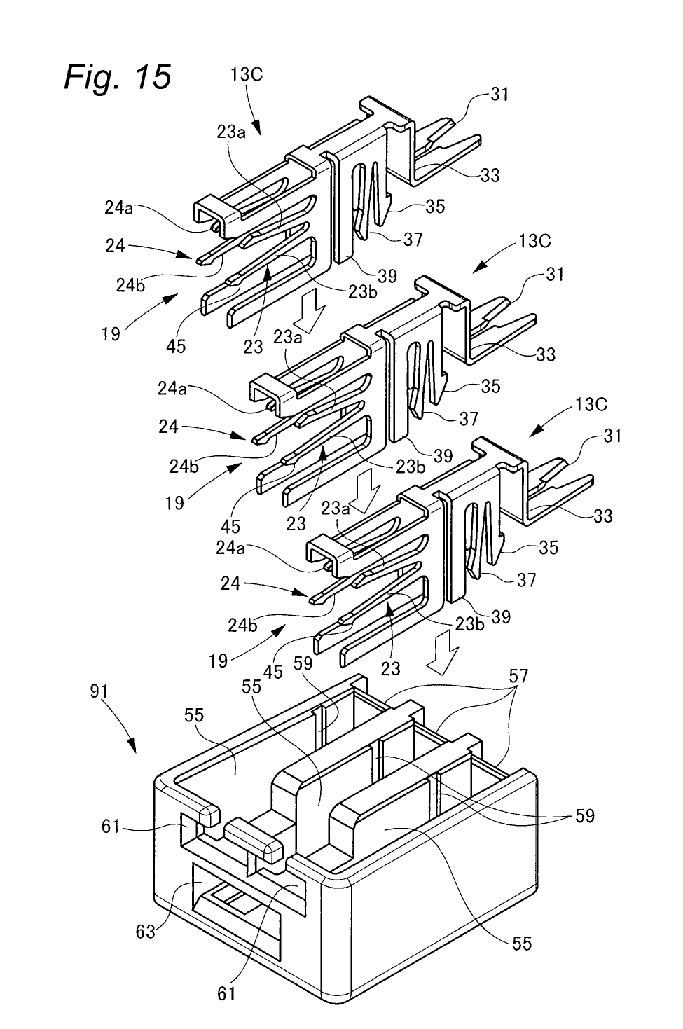

Referring to FIGS. 15 to 19, a two-lamp type LED unit 99 will be described which uses a connecting structure for electronic devices 11A according to a second embodiment. Like reference numerals will be given to substantially like constituent members to those of the LED unit 53 which uses the connecting structure for electronic devices 11 according to the first embodiment, and the detailed description thereof will be omitted herein.

A connecting structure for electronic devices 11A according to the second embodiment has three busbars 13C, shown in FIG. 15, which have the same shape as a main part of the configuration thereof. The three busbars 13C are accommodated in a housing 91 for use.

The three busbars 13C each have a terminal portion 19 which is formed at one end 17 thereof and are disposed parallel in three rows while being spaced apart from one another. The terminal portion 19 has at least a pair of contact elastic pieces 23, 24 which are disposed parallel to each other horizontally. The contact elastic pieces 23, 24 each include several vertically arranged contact elastic elements. The contact elastic elements include a pair of upper and lower contact elastic elements 23a, 23b/24a, 24b in this embodiment. In a sense, the upper contact elastic elements 23a, 24a of the contact elastic pieces 23, 24 form an upper pair of contact elastic elements which are disposed parallel to each other horizontally, and the lower contact elastic elements 23b, 24b thereof form a lower pair of contact elastic elements which are disposed parallel to each other horizontally. These contact elastic elements 23a, 24a, 23b, 24b can be brought into elastic contact with pairs of contact portions 21 of a plurality of electronic devices 11A. The number of the electronic devices 11A is three, and the number of the types of the electronic devices 11A is two, in this embodiment.

One busbar 13 has the pair of contact elastic pieces 23, 24 which are each caused to branch into a substantially Y-shape so that the one busbar 13 has the two pairs of contact elastic elements 23a, 24a, 23b, 24b in total towards distal ends of the contact elastic pieces 23, 24. In the six upper contact elastic elements 23a, 24a, 23a, 24a, 23a, 24a of the three busbars 13C which are disposed parallel in three rows, electric contact portions 45 of the four adjacent contact elastic elements 24a, 23a, 24a, 23a of the busbars 13C are connected to respective pairs of contact portions 21 of two semiconductor light emitting elements 25, which are first electronic devices 11A disposed between the three busbars 13C. In addition, in the six lower contact elastic elements 23b, 24b, 23b, 24b, 23b, 24b of the busbars 13C which are disposed parallel in three rows, electric contact portions 45 of the two contact elastic elements 23b, 24b of the busbars 13C, which are disposed spaced apart from each other so as to hold the two central contact elastic elements 24b, 23b of the central busbar 13 therebetween, are connected to a pair of contact portions 21 of a Zener diode 27, which is a second electronic device 11A which is disposed below the two semiconductor light emitting elements 25 between the three busbars 13C. In the second embodiment, a contact-to-contact pitch of the Zener diode 27 used is three times a pitch defined between contacts of the electric contact portions 45.

Namely, in FIG. 15, one of the semiconductor light emitting elements 25 is connected to the second leftmost electric contact portion 45 and the third leftmost electric contact portion 45 in the upper electric contact portions 45 of the busbars 13C which are disposed parallel in three rows. The other semiconductor light emitting element 25 is connected to the fourth leftmost electric contact portion 45 and the fifth leftmost electric contact portion 45. In addition, the Zener diode 27 is connected to the second leftmost electric contact portion 45 and the fifth leftmost contact portion 45 in the lower electric contact portions 45 of the busbars 13C which are disposed parallel in three rows.

Next, assembling steps of the connecting structure for electronic devices 11A will be described.

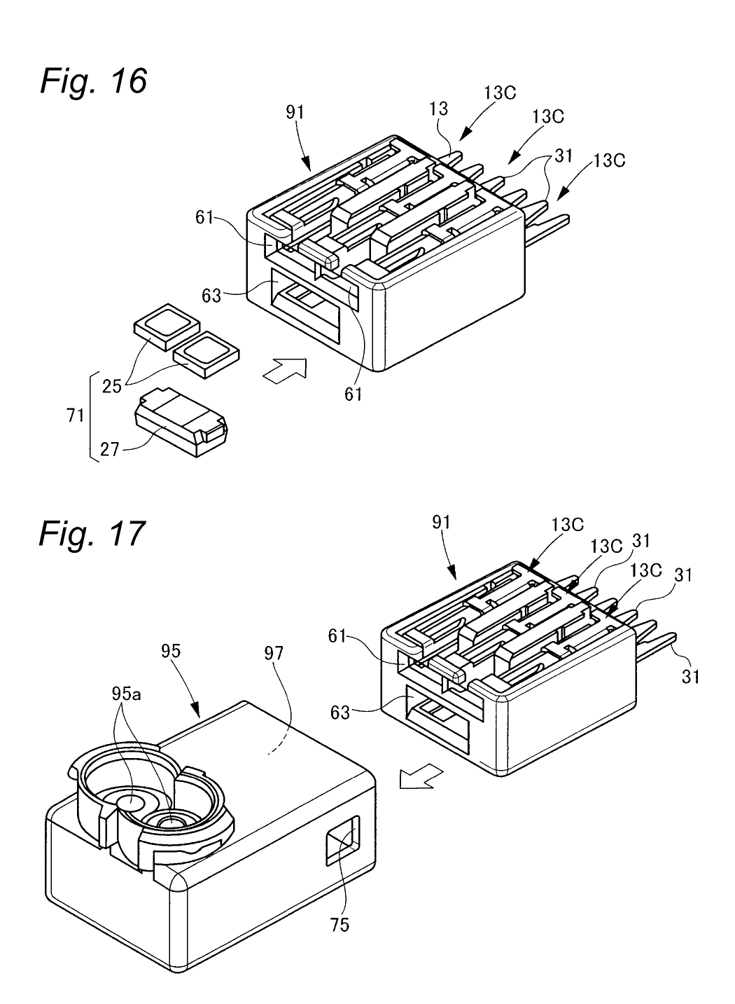

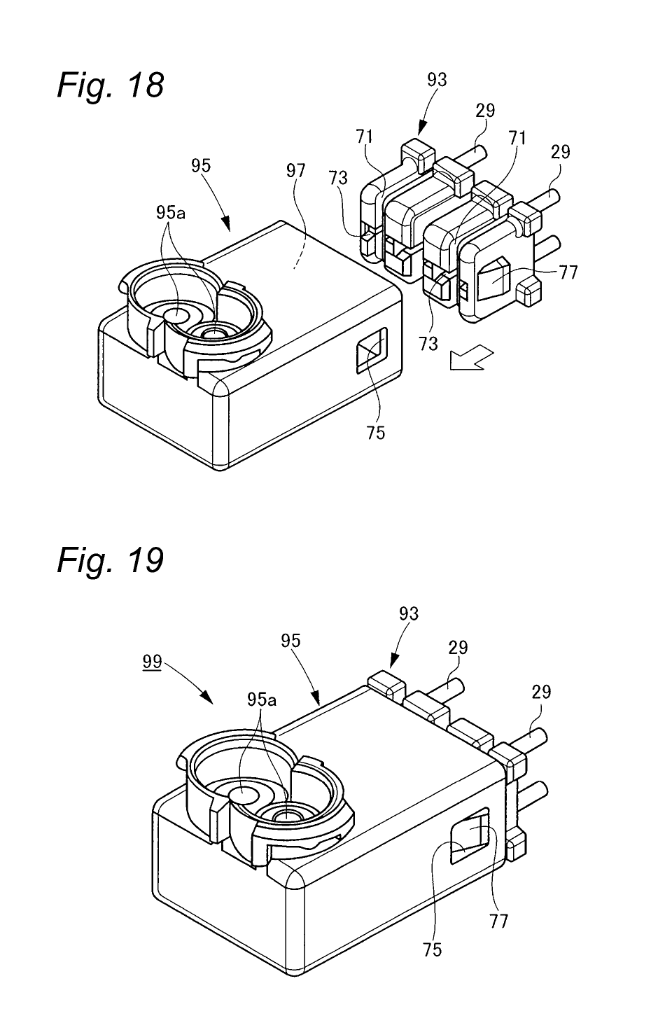

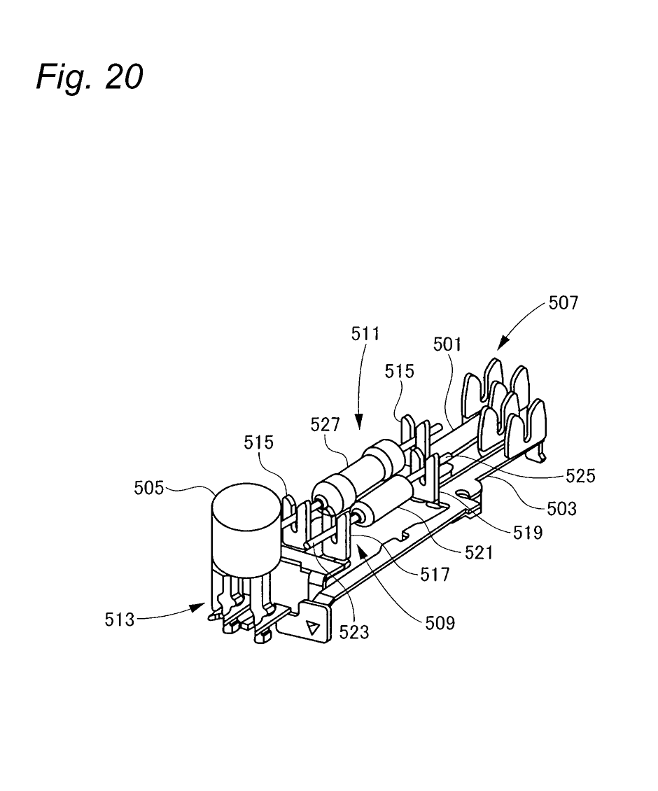

FIG. 15 is a drawing which depicts a busbars assembling step in the connecting structure for electronic devices 11A according to the second embodiment of the invention, FIG. 16 is a drawing which depicts similarly an electronic devices assembling step, FIG. 17 is a drawing which depicts similarly a housing assembling step, FIG. 18 is a drawing which depicts similarly an electric wire holder assembling step, and FIG. 19 is a perspective view of the LED unit 99 which uses the connecting structure for electronic devices 11A according to the second embodiment of the invention.

The connecting structure for electronic devices 11A can preferably be applied, for example, to the two-lamp type LED unit 99. In order to apply the connecting structure for electronic devices 11A to the two-lamp type LED unit 99, as FIG. 15 shows, the three busbars 13C are mounted in a housing 91.

Three busbar accommodation compartments 55 are formed in the housing 91. In each of the busbar accommodation compartments 55, a rear wall 57 is provided at a rear end thereof, and a pair of holding grooves 59 are formed in inner wall surfaces lying forwards of the rear wall 57. When the busbar 13C is inserted in the busbar accommodation compartment 55, the rear wall 57 is held by a rear abutment piece 33 and rear elastic legs 35 of the busbar 13C therebetween, so that the busbar 13C is mounted in the housing 91 while being restricted from being dislodged therefrom.

As FIG. 16 shows, two left and right LED mounting opening portions 61 and a diode mounting opening portion 63 are formed vertically in a front side of the housing 91. The semiconductor light emitting elements 25 are inserted individually into the LED mounting opening portions 61 in such a state that the contact portions 21 are oriented downwards. The Zener diode 27 is inserted into the diode mounting opening portion 63 in such a state that the contact portions 21 are oriented upwards. By adopting this configuration, the contact portions 21 of the semiconductor light emitting elements 25 and the contact portions 21 of the Zener diode 27 are connected to their corresponding electric contact portions 45. In addition, a resistor mounting opening portion (not shown) is formed in a bottom side of the housing 91, and a resistor 28 is inserted thereinto. By adopting this configuration, the resistor 28 is held by front abutment pieces 39 and front elastic legs of the busbar 13C on a near side therebetween, and electric contact portions of the front elastic legs 37 are connected to a pair of contact portions of the resistor 28.

As FIG. 17 shows, the two semiconductor light emitting elements 25 and the Zener diode 27 are mounted in the housing 91, and then, the housing 91 is mounted in a lens cover 95 which includes two lenses 95a. A housing inserting opening 97 is formed in a rear end face of the lens cover 95. In the housing 91 which has been inserted in the lens cover 95, press contact blades 31 project rearwards in an interior of the lens cover 95.

As FIG. 18 shows, an electric wire holder 93 is inserted into the lens cover 95 into which the housing 91 has been mounted from the housing inserting opening 97. U-shaped electric wire holding grooves 71 are formed at three locations on three external sides of the electric wire holder 93. Covered electric wires 29 are each bent into a U-shape and are mounted individually in the electric wire holding grooves 71 formed laterally outwards. Horizontal press contact blade entrance slits 73 are formed in a front side of the electric wire holder 93 so as to extend over the corresponding electric wire holding grooves 71. By adopting this configuration, when the electric wire holder 93 is inserted into the lens cover 95, the press contact blades 31 of the busbars 13C, which project rearwards in the interior of the lens cover 95, enter the press contact blade entrance slits 73 so that the press contact blades 31 and conductors of the electric wires 29 are connected to each other.

When the electric wire holder 93 is inserted into the lens cover 95, locking claws 77 provided on lateral sides of the electric wire holder 93 so as to project therefrom are locked in locking holes 75 formed in lateral side portions of the lens cover 95, whereby the housing 91 and the electric wire holder 93 are restricted from being dislodged from the lens cover 95. When the housing 91 and the electric wire holder 93 are mounted in the lens cover 95, the two-lamp type LED unit 99 shown in FIG. 19 is completed.

In this way, in the connecting structure for electronic devices 11A according to the second embodiment of the invention, the three busbars 13C each have the terminal portion 19 including the two upper and lower pairs of contact elastic elements 23a, 24a, 23b, 24b which face each other horizontally, and the three busbars 13C are disposed parallel in three rows. Then, In the six upper contact elastic elements 23a, 24a, 23a, 24a, 23a, 24a of the three busbars 13C which are disposed parallel in three rows, the electric contact portions 45 of the four adjacent contact elastic elements 24a, 23a, 24a, 23a of the busbars 13C are connected to the respective pairs of contact portions 21 of the two semiconductor light emitting elements 25. In addition, in the six lower contact elastic elements 23b, 24b, 23b, 24b, 23b, 24b of the busbars 13C which are disposed parallel in three rows, the electric contact portions 45 of the two contact elastic elements 23b, 24b of the busbars 13C, which are disposed spaced apart from each other so as to hold the two central contact elastic elements 24b, 23b of the central busbar 13 therebetween, are connected to the pair of contact portions 21 of the Zener diode 27 which is disposed below the two semiconductor light emitting elements 25 between the three busbars 13C. Thus, the electronic devices 11A having the different external shapes, sizes and contact-to-contact pitches can be connected together.

In the two-lamp type LED unit 99 according to the second embodiment, the two light emitting semiconductors 25 can still emit light without mounting the Zener diode 27, thereby making it possible to omit the Zener diode 27 so as to reduce the number of parts to be mounted.

According to the connecting structure for electronic devices according to the invention, the surface mount electronic devices having the different contact-to-contact pitches, external shapes and sizes can be connected with the busbars of one type.

According to the connecting structure for electronic devices of the present invention, the plurality of busbars each having the terminal portion are disposed parallel to each other with the space defined therebetween, and the terminal portion has at least the two upper and lower pairs of contact elastic elements. Then, any two contact elastic elements of the upper and lower contact elastic elements of the elastic pieces are connected respectively to the pairs of contact portions of the plurality of types of electronic devices which are disposed between the busbars. Thus, the plurality of types of electronic devices having the different contact-to-contact pitches, external shapes and sizes can be connected to electric contact portions which are formed vertically in the terminal portions between the busbars which are disposed parallel to each other.

According to the electronic devices connecting portions of the present invention, the busbars each has the pair of contact elastic pieces which are each caused to branch into the substantially Y-shape and the two upper and lower pairs of contact elastic elements are formed at the distal ends of the pair of contact elastic pieces. Thus, by disposing the two busbars like the busbars parallel to each other with the space defined therebetween, in total, eight electric contact portions are disposed on the upper and lower pairs of contact elastic elements with four electric contact portions disposed on each of the upper and lower pairs. By adopting this configuration, in either of the upper and lower pairs, the pair of contact portions of the first electronic device having a smaller contact-to-contact pitch can be connected to the electric contact portions of the adjacent contact elastic elements, while in the other pair, the pair of contact portions of the second electronic device having a larger contact-to-contact pitch can be connected to the electric contact portions of the contact elastic elements which are disposed spaced apart from each other so as to hold at least the electric contact portion of the contact elastic element therebetween.

According to the connecting structure for electronic devices of the present invention, the main body of the busbar is formed by being bent into the U-shape, and the two upper and lower pairs of contact elastic elements are formed at the distal ends of the contact elastic pieces which are each caused to branch into the substantially Y-shape in the pair of lateral side walls which face each other through punching. By adopting this configuration, the elastic contact construction having a number of electric contact portions can be fabricated compact with ease.

According to the connecting structure for electronic devices of the present invention, the light emitting portion of the semiconductor light emitting element is disposed in such a state that the light emitting portion is held between the two busbars which are disposed parallel to each other with the space defined therebetween. The reflecting surfaces are formed on the lateral side walls of the two busbars which hold the light emitting portion therebetween, whereby light emitted from the light emitting portion is reflected on the reflecting surfaces so as to be directed in the direction of emission of light, thereby making it possible to make effective use of light emitted from the light emitting portion.

The present application is based on Japanese Patent Application No. 2010-258229 filed on Nov. 18, 2010 and Japanese Patent Application No. 2011-180846 filed on Aug. 22, 2010, the contents of which are incorporated herein by way of reference.

The present invention is extremely useful in providing a connecting structure for electronic devices in which a plurality of types of surface mount electronic devices having different contact-to-contact pitches, external shapes and sizes can be connected to various forms of connecting circuits with one type of busbars.

What is claimed is:

1. A connecting structure for electronic devices, the connecting structure comprising:
a plurality of busbars arranged parallel to each other with a space therebetween, wherein
each of the busbars has a terminal part,
the terminal part has at least two pairs of contact elastic pieces,
each of the pairs of the contact elastic pieces consists of two contact elastic pieces arranged laterally,
the pairs of the contact elastic pieces are vertically arranged so as to form layers,
each of the contact elastic pieces of the busbars is configured to elastically come in contact with one of contact portions of at least one of electronic devices, and
at least two of the contact elastic pieces disposed in same one of the layers are elastically come in contact with the contact portions of the electronic device respectively, when the one of the electronic devices is attached to the connecting structure.

2. The connecting structure as set forth in claim 1, wherein
the electronic devices include a first electronic device and a second electronic device,
two of the busbars are provided in the connecting structure,
each of the busbars includes a pair of contact members arranged laterally,
an end part of each of the contact members is branched to form two of the contact elastic pieces,
four of the contact elastic pieces are arranged in each of two layers,
two of the contact elastic pieces which are adjacent with each other are configured to be come in contact with a pair of the contact portions of the first electronic device respectively in one of the two layers, and
two of the contact elastic pieces between which at least one of the contact elastic pieces is arranged are configured to be come in contact with a pair of the contact portions of the second electronic device respectively in the other of the two layers.

3. The connecting structure as set forth in claim 2, wherein
each of the busbars is formed by being bent a plate into a U-shape so that each of the busbars includes a pair of side walls disposed in parallel to each other, and
the contact elastic pieces are formed by punching the side walls.

4. The connecting structure as set forth in claim 1, wherein
the one of the electronic devices is a semiconductor light emitting element,
a light emitting portion of the semiconductor light emitting element is disposed between two of the busbars, and
reflecting surface are formed on each of side surfaces of the busbars between which the light emitting portion is disposed.
